(19) United States
(12) Patent Application Publication
(10) Pub. No.: US 2012/0134776 A1
(43) Pub. Date: May 31, 2012

(54) Nozzle Capable of Maximizing the Quantity of Movement Produced by a Two-Phase Flow Through the Relief of a Saturating Flow

(75) Inventors: Elias Bou Lawz Ksayer, Paris (FR); Denis Clodic, Palaiseau (FR)

(73) Assignee: ASSOCIATION POUR LA RECHERCHE ET LE DEVELOPPEMENT DES METHODES ET PROCESSUS INDUSTRIELS ARMINES, Paris (FR)

(21) Appl. No.: 13/265,780

(22) PCT Filed: Mar. 29, 2010
(86) PCT No.: PCT/FR2010/050576

§ 371 Date: Jan. 9, 2012

(30) Foreign Application Priority Data
Apr. 21, 2009 (FR) 0952611

(51) Int. Cl. F01D 1/34; B05B 1/00; F01D 1/18

(52) U.S. Cl. 415/80; 416/20 R; 222/566

(57) ABSTRACT

The nozzle (10) is suitable for expanding a saturated flow (D) and comprises a converging portion (2), a throat (3), a tube (4), and a mixer element (5) downstream from said throat (3) and suitable for mixing the vapor and liquid phases of the saturated flow.

### BACKGROUND OF THE INVENTION

The invention lies in the field of ejectors and nozzles used as expansion members in turbines.

In general, such devices are designed to transform pressure energy into kinetic energy, the kinetic energy then being used to produce work, e.g. to cause turbine blades or buckets to revolve, or with ejectors it is used to suck in a flow.

Such devices are commonly used to expand vapor or liquids that are highly sub-cooled.

In contrast, the use of ejectors or nozzles to expand saturated liquids remains marginal, since the appearance of a vapor phase puts a considerable limit on the quantity of momentum in the liquid/vapor two-phase flow after expansion.

FIGS. 1 to 4 illustrate this phenomenon. FIG. 1 shows a nozzle 1 in accordance with the present state of the art. The nozzle 1 comprises a converging portion 2, a throat 3, and a diverging portion 4 of moderate angle. A flow of saturated liquid D enters the nozzle 1 via the converging portion 2, and travels along the nozzle from right to left through the throat 3 and then through the moderately diverging portion 4.

Along the abscissa axis, FIG. 2 shows the measured pressure of the flow D as it travels along the nozzle 1 of FIG. 1, and up its ordinate axis it plots the mass velocity ρ·V, i.e. the product of the density ρ multiplied by the velocity V. It should be observed that this mass velocity is at a maximum in the throat 3 (identified by the vertical line).

FIG. 3 shows how the uniform liquid-vapor density (ρ expressed in kilograms per cubic meter (kg/m²)) of the flow D varies as a function of the pressure (P measured in megapascals (MPa)) as it travels along the nozzle 1. These results are obtained by calculation and they show that the density ρ decreases with the appearance of the vapor phase during the drop in pressure along the nozzle.

FIG. 4 shows the variation in the velocity (V expressed in meters per second (m/s)) of the flow D as a function of its pressure (P expressed in MPa) as it travels along the nozzle 1.

These results, obtained by testing, show that the real increase in the velocity of the two-phase mixture coming from the drop in density due to the partial vaporization of the liquid (dashed line curve) departs greatly from the theoretical variation (continuous line curve).

Such bad performance has severely limited the development of two-phase turbines, with some people even believing that they are of no use, industrially.

The invention seeks to mitigate the drawbacks of the prior art by proposing, in a first aspect, a nozzle suitable for maximizing the quantity of momentum produced by a liquid/vapor two-phase flow coming from the expansion of a saturated liquid.

It is also known that ejectors such as two-phase turbines make it possible to obtain greater energy performance in particular for refrigerator systems or heat pumps that have isenthalpic expanders.

At present, turbines and ejectors are in widespread use for expanding liquids that remain liquid or vapors that remain mainly vapor; those thermodynamic expansion variations come close to ideal isentropic expansion. For a given pressure difference and for the expansion of a liquid, such isentropic expansion sets the minimum fraction of vapor that can be generated from the expansion of said high-pressure saturated liquid.

FIG. 5 shows a refrigeration cycle with vapor compression in the form of a T/S diagram, in which the entropy per unit mass S (expressed in kilojoules per kilogram-kelvin (kJ/kg·K)), and temperature T (expressed in kelvins) are plotted respectively along the abscissa axis and up the ordinate axis.

This diagram shows:
between states 101 and 102, compression of the refrigerant fluid in the vapor phase, from evaporation low pressure to condensation high pressure; and
between states 102 and 103, a stage of de-superheating the vapor followed by condensation in which the refrigerant liquid becomes a saturated liquid.

The transition between the point 103 (condensation high pressure) and the point 104ᵢₜₕ (evaporation low pressure) illustrates isenthalpic expansion in the present state of the art. The quantity of vapor that is generated during this expansion is at a maximum.

Such isenthalpic expansion is far from achieving ideal isenthalpic expansion performance as shown in FIG. 5 by the transition between the condensation high pressure (point 103) and the theoretical point (point 104ᵢₛ). With isentropic expansion, the quantity of vapor that is generated is at a minimum and the evaporation entropy difference of the saturated liquid is much greater than with isenthalpic expansion.

It should be recalled that isenthalpic expansion typically takes place in an orifice having upstream and downstream sections that are much greater than the size of the orifice, the sudden narrowing and sudden widening on either side of the orifice serving to create a head loss that is very significant in addition to that of the orifice.

In a turbine or in an ejector, it is known to limit head loss by bringing the fluid to the throat via a converging portion. Tests and a few scientific articles show that the expansion in the converging portion is quasi-isentropic up to the throat.

It is then fundamental to observe that the velocity of the liquid downstream from the throat remains substantially identical to the velocity it had in the throat, in other words the pressure energy is not converted into kinetic energy.

This phenomenon is shown in FIGS. 6A to 6C which are described below. FIG. 6A shows a prior art ejector 60. This ejector mainly comprises a nozzle 1 of the kind described with reference to FIG. 1, and a hollow body 62.

The role of the nozzle 1 is to expand a flow of saturated liquid F1 at high pressure P_{F1S1} to a theoretical low pressure P_{Th}_{_{—}}_{F1S3} by increasing its speed so as to entrain a fluid flow F2 at a pressure P_{F2S2} that is significantly less than P_{F1S1}.

This fluid flow F2 is usually a flow of vapor coming from evaporation of a fluid having an evaporation pressure P_{F2s2} that is less than the pressure P_{F1S1} and less than the pressure P_{Th}_{_{—}}_{MixS5} of the mixture after ejection.

The hollow body 62 has a converging portion 63, a mixing chamber 64 of constant section S4, and a conical diverging portion 65 of maximum section S5.

The flow F1 enters the nozzle 1 via the section S1 and it expands in a primary two-phase flow to its outlet of section S3.

The following notation is used:
V_{F1S1}: the velocity of the primary flow F1 at the section S1;
P_{F1S1}: the pressure of the primary flow F1 at the section S1;
F_{Th}_{_{—}}_{F1S3}: the theoretical velocity of the primary flow F1 at the section S3; and
P_{Th}_{_{—}}_{F1S3}: the theoretical pressure of the primary flow F1 at the section S3.

The flow F2 enters into the ejector 60 via a section S2. It is entrained and accelerated in a so-called “secondary” flow by the primary flow F1 as a result of the pressure difference between the sections S3 and S2.

The following notation is used:
V_{F2S2}: the velocity of the secondary flow F2 at the section S2;
P_{F2S2}: the pressure of the secondary flow F2 at the section S2; and
V_{Th}_{_{—}}_{F2S3}: the theoretical velocity of the secondary flow F2 at the section S3.

The primary and secondary flows F1 and F2 begin to mix in the converging portion 63 at constant pressure and they then enter into the mixing chamber 64 in which they form a two-phase mixture at a theoretical velocity V_{Th}_{_{—}}_{MixS4} and a theoretical pressure P_{Th}_{_{—}}_{MixS4}.

The diverging portion 65 forms a diffuser for accelerating the two-phase mixture of the fluid flows F1 and F2 up to a speed V_{Th}_{_{—}}_{MixS5} and to transform the kinetic energy into pressure potential energy. The pressure of the mixture increases in the diverging portion 65 up to a theoretical outlet pressure P_{Th}_{_{—}}_{MixS5}.

However, in reality, it is found that the real velocity F_{Nox}_{_{—}}_{F1S3} of the primary flow F1 as measured at the outlet from the throat 3 is much less than the theoretical velocity V_{Th}_{_{—}}_{F1S3}.

Consequently:
the entrainment of the secondary flow F2 is less than in theory;
the real pressure P_{Nox1}_{_{—}}_{MixS4} of the mixture at the outlet from the mixing chamber 64 is less than the theoretical pressure P_{Th}_{_{—}}_{MixS4}; and as a result
the real outlet pressure P_{Noz1}_{_{—}}_{MixS5} is less than the theoretical outlet pressure P_{Th}_{_{—}}_{MixS5}.

This state of affairs is shown in FIGS. 6B and 6C where the above-defined pressures and velocities are shown respectively, theory being represented by a fine line and prior art performance by a bold dashed line.

The invention also seeks to provide an ejector that does not present the drawbacks of the present state of the art.

### OBJECT AND SUMMARY OF THE INVENTION

More precisely, the invention relates to a nozzle suitable for expanding a saturated flow. The nozzle comprises a converging portion, a throat, a tube, and a mixer element situated inside the tube downstream from the throat, the mixer element being suitable for fractionating the saturated liquid phase in order to mix it with the vapor phase.

Thus, and in general, the nozzle of the invention seeks to mix the vapor and liquid phases of the saturated liquid downstream from the throat, whereas in the present state of the art, it is sought to process those two phases separately.

The Applicant has found that in prior art nozzles, the liquid and the vapor separate at the outlet from the throat, where the enlargement occurs. Downstream from the throat, the Applicant has observed slip between the liquid phase and the vapor phase: the vapor phase seeks to occupy all of the volume that is made available thereto, and it spreads over the periphery of the liquid flow, which remains central. Consequently, the jet of liquid at the outlet from the converging portion is not accelerated by the vapor formed by the expansion, since the vapor takes up a position at the periphery of the liquid jet.

The invention thus proposes mixing the vapor and liquid phases, thereby considerably increasing the momentum that is produced by the liquid/vapor two-phase flow coming from the expansion of the saturated liquid, as is explained below.

In a particular embodiment, the tube is a diverging portion of increasing section, e.g. of conical section. The cone angle of this conical tube may be selected to maintain the mass flow constant during acceleration of the two-phase flow.

In a variant, the moderately conical diverging portion 4 may be replaced by a cylindrical tube.

In a particular embodiment, the converging portion of the nozzle of the invention includes a needle for varying the section of the throat.

In a particular embodiment, the above-mentioned mixer element is a stationary helix.

In a variant, the helix may be movable.

In another embodiment of the invention, the mixer element may include shapes of revolution of increasing sections.

The nozzle of the invention may be used in numerous devices, and in particular in an ejector, in a Hero turbine, in a Pelton turbine, or in a Francis turbine.

More precisely, the invention also provides an ejector comprising a hollow body, the hollow body comprising a converging portion, a mixing chamber, and a diverging portion, the ejector including, in the converging portion, an expansion nozzle as mentioned above, the nozzle being suitable for expanding a primary flow of saturated liquid in order to entrain a secondary flow introduced into the converging portion around the nozzle.

The invention thus makes it possible to mix in satisfactory manner the vapor and liquid phases of the primary flow and to entrain the secondary flow much more efficiently than is possible in ejectors of the state of the art. As a result, a real outlet pressure is obtained that is very close to the theoretical outlet pressure.

The invention also provides a Hero turbine including one or more hollow arms movable in rotation about a shaft, the shaft feeding the hollow arm(s) with saturated liquid, said turbine including an expansion nozzle as mentioned above at the end of each of the hollow arms.

The invention also provides a Pelton turbine including at least two buckets secured to a wheel that is movable in rotation about an axis, the turbine including at least one expansion nozzle as mentioned above suitable for projecting a two-phase jet towards the buckets.

The invention also provides a Francis type turbine including at least one expansion nozzle as mentioned above and suitable for projecting a two-phase jet into the inside of a rotor of said turbine.

In a particular embodiment, the ejector of the invention includes a second mixer element, in part in the mixing chamber and in part in the diverging portion. This characteristic encourages mixing of the two-phase flow of the primary flow at the outlet of the nozzle with the secondary flow.

### BRIEF DESCRIPTION OF THE DRAWINGS

Other characteristics and advantages of the present invention appear from the following description given with reference to the accompanying drawings that show an embodiment having no limiting character. In the figures:

FIG. 1 shows a prior art nozzle;

FIGS. 2 to 4 show pressure and velocity values for a saturated flow passing through the FIG. 1 nozzle;

FIG. 5 is a T/S diagram showing a vapor compression refrigeration cycle;

FIG. 6A shows a prior art ejector;

FIGS. 6B an 6C show pressure and velocity values for primary and secondary flows passing through the FIG. 6A ejector;

FIGS. 7A and 7B show a nozzle in accordance with a particular embodiment of the invention;

FIG. 8 shows a mixer element suitable for being used in the invention;

FIG. 9 shows pressure and velocity values of a saturated flow passing through the nozzle of FIGS. 7A and 7B;

FIGS. 10A and 10B show a Hero turbine in a first particular embodiment of the invention;

FIG. 10C is a diagram of a Hero turbine in a second particular embodiment of the invention;

FIG. 11 shows a Pelton turbine in accordance with a particular embodiment of the invention;

FIG. 12 shows a Francis turbine in accordance with a particular embodiment of the invention;

FIG. 13A shows an ejector in accordance with a particular embodiment of the invention; and

FIGS. 13B and 13C show pressure and velocity values of primary and secondary flows passing through the FIG. 13A ejector.

### DETAILED DESCRIPTION OF AN EMBODIMENT

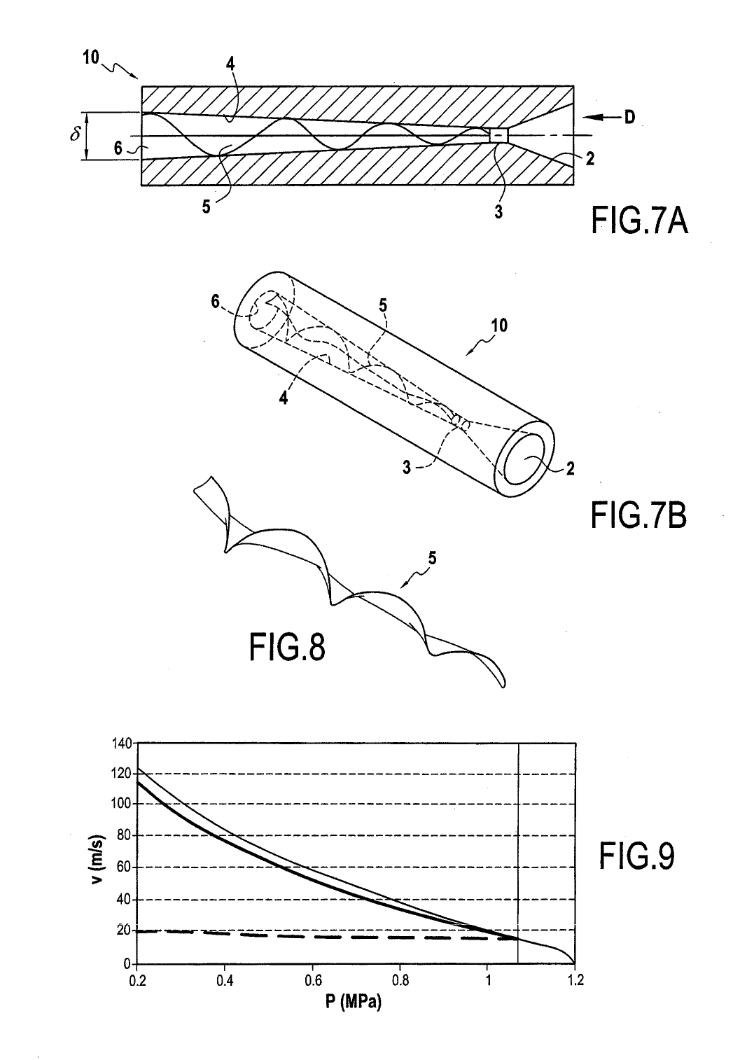

FIGS. 7A and 7B show a nozzle 10 in accordance with the invention.

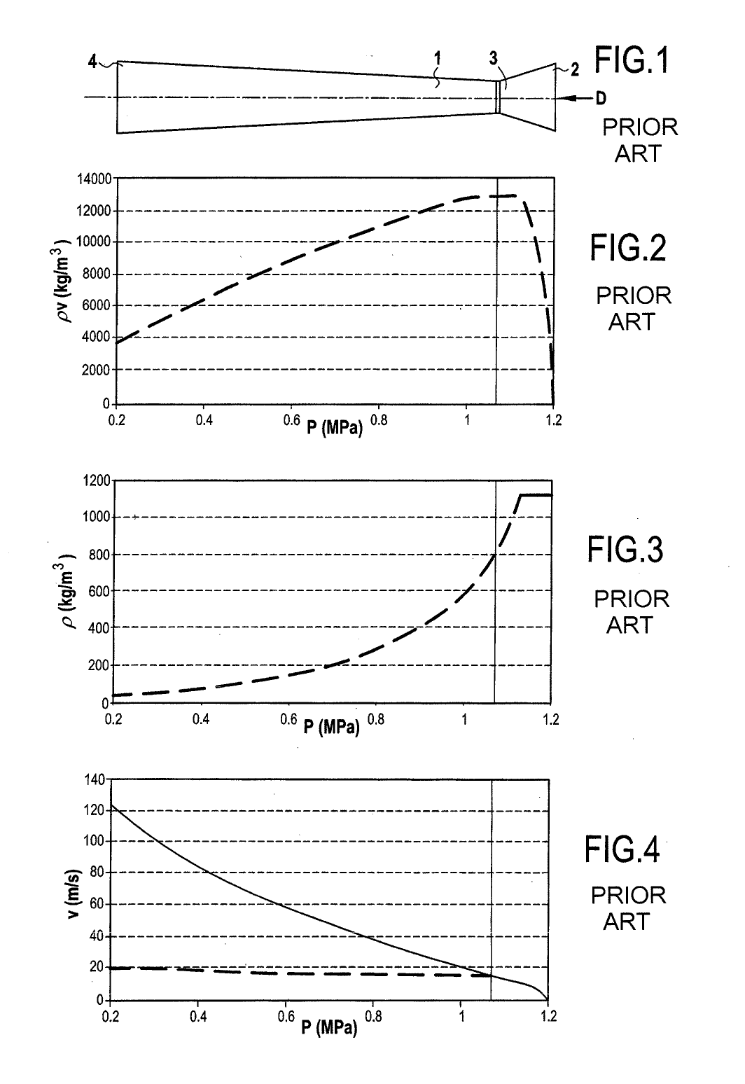

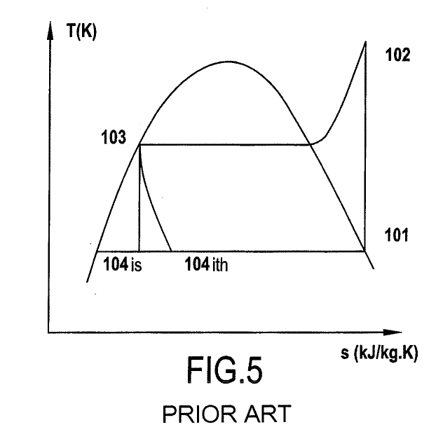

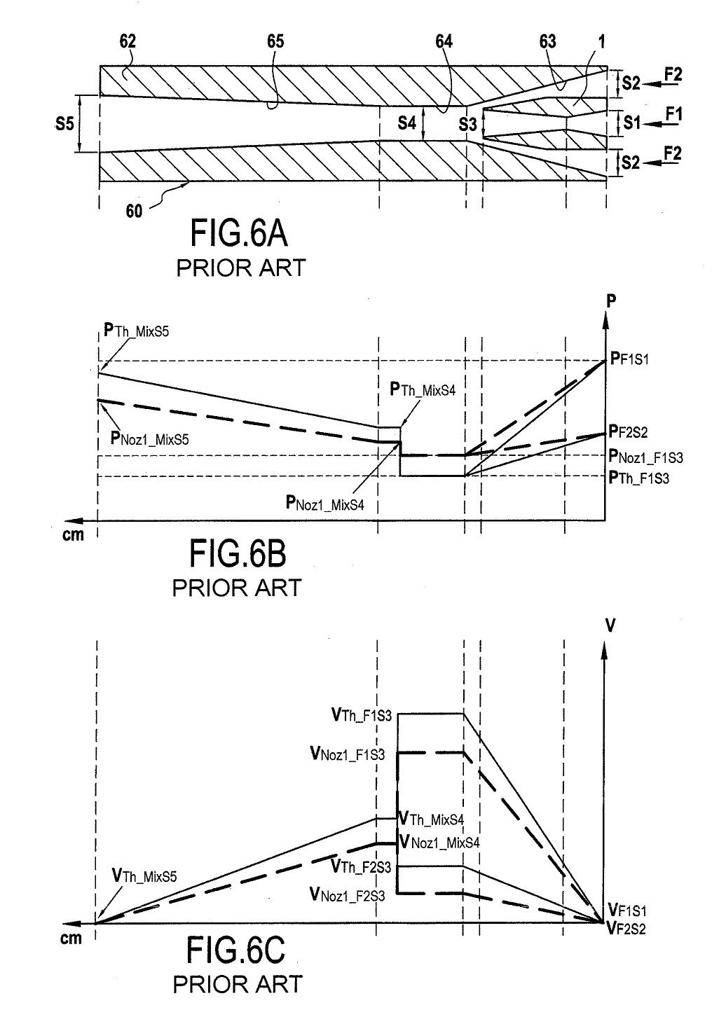

It differs from the nozzle 1 of FIG. 1 in that it includes a mixer element 5 downstream from the throat 3, the mixer element being suitable for creating uniform mixing of the vapor and liquid phases in the moderately diverging portion 4, with this having the consequence of considerably increasing the momentum of the two-phase flow at the outlet from the diverging portion 4.

In the embodiment described herein, the moderately diverging portion 4 of the nozzle 10 in accordance with the invention is of a lightly flaring conical shape so as to maintain a mass flow rate that is constant during the acceleration of the two-phase flow.

In the embodiment shown herein, the mixer element 5 is constituted by a stationary helix, as shown in FIG. 8.

In FIG. 9, a continuous bold line shows the variation in the velocity V of the flow D as a function of pressure as it travels along the nozzle 10. This figure reproduce the curves of FIG. 4 by way of comparison. It serves to demonstrate that introducing the helically-shaped mixer element 5 downstream from the throat 3 makes it possible to approach the theoretical curve (fine continuous line).

Returning to FIGS. 7A and 7B, the velocity of the flow D at the outlet from the nozzle 10 may be adjusted by varying the diameter 5 at the outlet 6 of the nozzle.

In the example of FIG. 9, the outlet flow velocity from the nozzle 10 in accordance with the invention is equal to 110 m/s, which is much greater than the velocity of 20 m/s obtained in the absence of the mixer 5.

It is known that the energy available at the outlet from a nozzle is given by the relationship V²/2.

Consequently, the available kinetic energy (6050 J/kg) at the outlet from the nozzle 10 of the invention is about 30 times greater than that obtained at the outlet from the prior art nozzle 1 (200 J/kg).

The nozzle 10 of the invention may be incorporated in particular in a turbine or in a two-phase ejector.

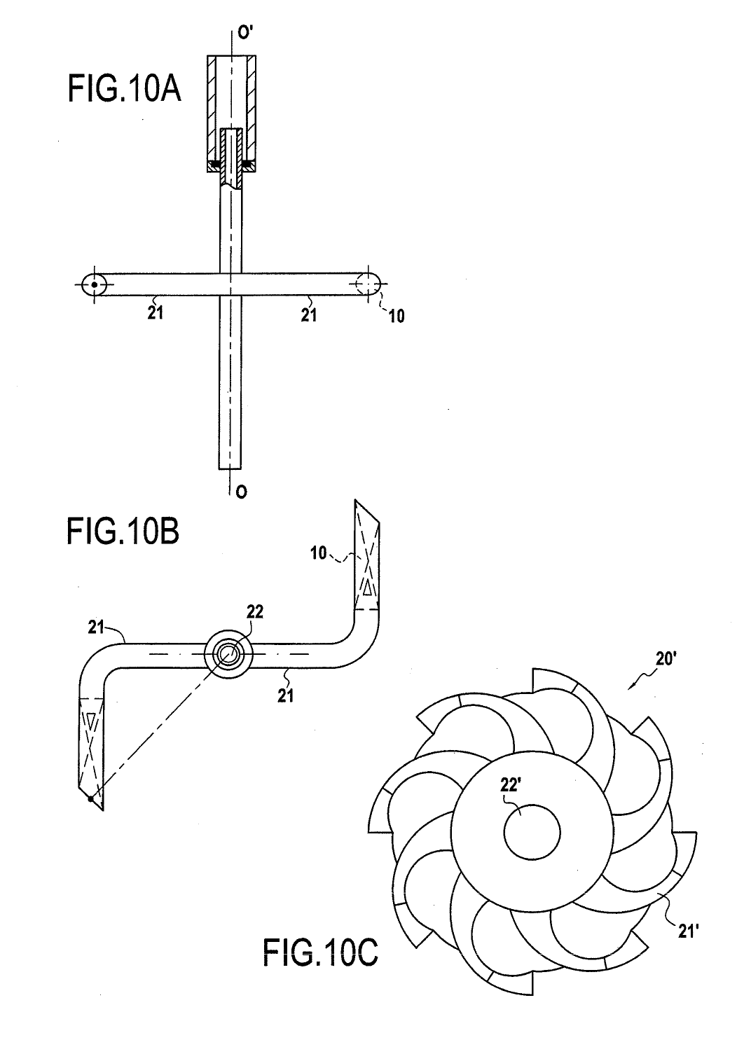

FIGS. 10A and 10B show a Hero type two-phase turbine 20 in accordance with the invention in face view and in plan view, respectively.

In the embodiment described herein, the turbine 20 has two hollow arms 21, each of these arms including a nozzle 10 in accordance with the invention at its end.

The hollow arms 21 are movable in rotation about a hollow shaft 22 suitable for feeding the hollow arms with saturated liquid.

It is recalled that in a Hero type turbine, work is recovered directly from the shaft 22 as a result of the impulse from the jets leaving the arms 21 tangentially.

FIG. 10C shows another Hero type turbine 20′ in accordance with the invention, having eight hollow arms 21′ distributed around a saturated liquid feed shaft 22′, each arm 21′ including a nozzle 10 in accordance with the invention (not shown).

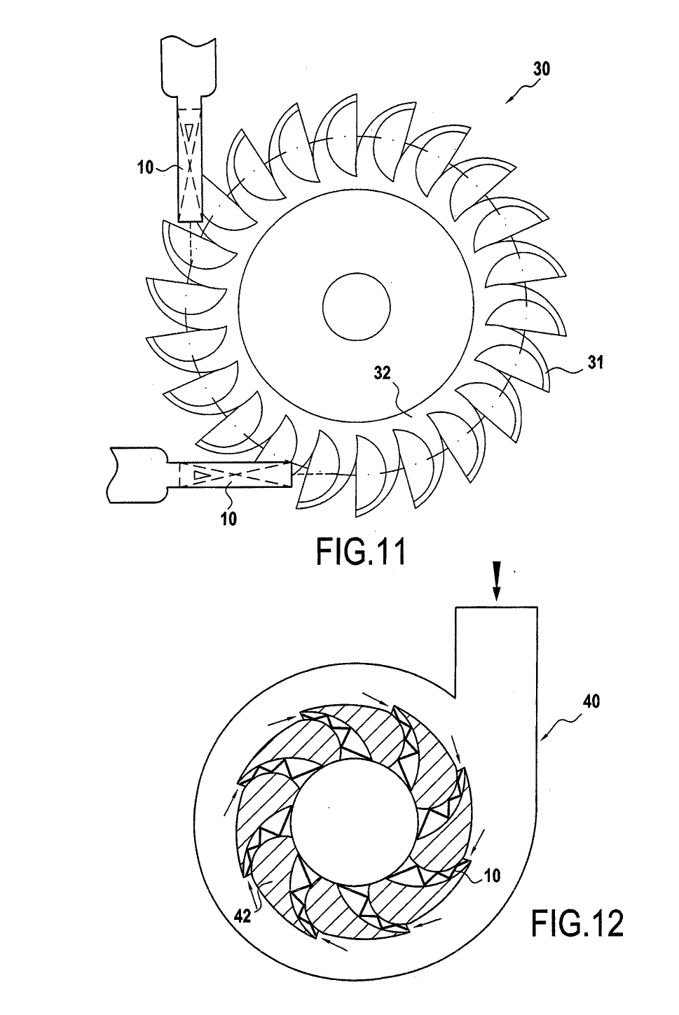

FIG. 11 shows a Pelton two-phase turbine 30 in accordance with the invention. This turbine 30 has two nozzles 10 of the invention, with the two-phase jets that leave these nozzles striking buckets 31 secured to a rotary wheel 32 in order to set it into motion.

FIG. 12 shows a Francis type two-phase turbine 40 in accordance with the invention. This turbine 40 has eight nozzles 10 of the invention, with the two-phase jets that leave these nozzles being directed to the inside of a rotor 42.

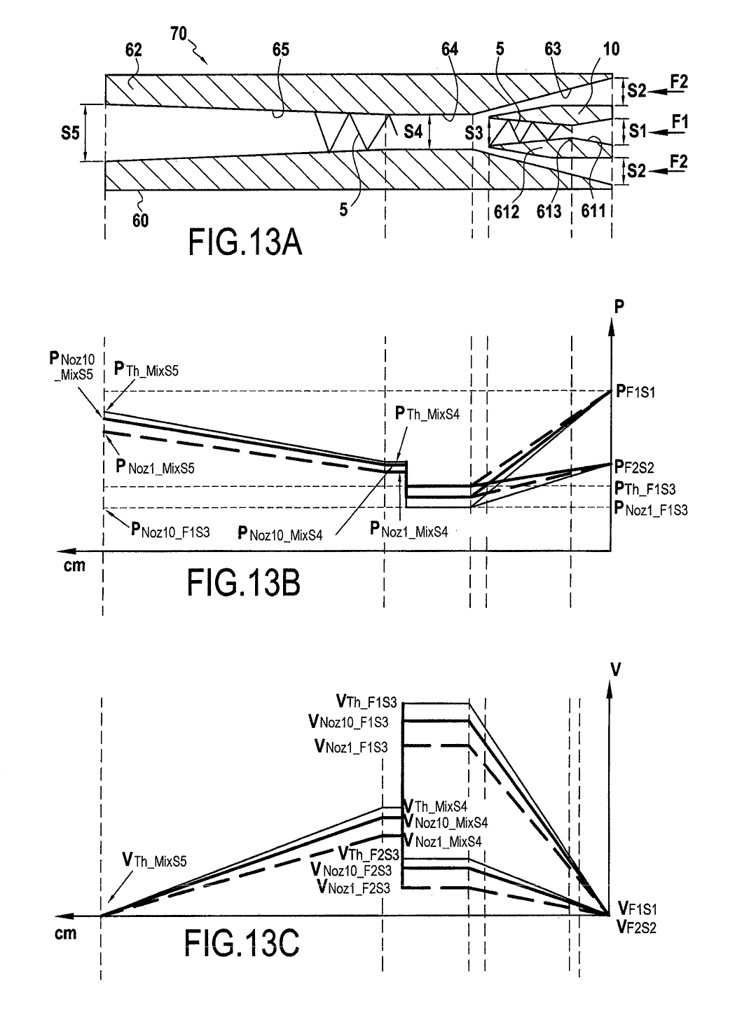

FIG. 13A shows an ejector 70 in accordance with the invention.

It differs from the ejector 60 of the state of the art in that, as a replacement for the nozzle 1, it includes a nozzle 10 in accordance with the invention, in which the helix 5 generates a vortex for mixing together the vapor and liquid phases of the primary flow F1.

The pressures and velocities obtained in the ejector 70 of the invention are shown respectively in FIGS. 13B and 13C. It can be seen therein, in particular, that the use of the nozzle 10 enables the real velocity V_{Noz10}_{_{—}}_{F1S3} of the primary flow F1 at the section S3 of said nozzle 10 to be very close to the theoretical velocity V_{Th}_{_{—}}_{F1S3}.

Furthermore, in the embodiment described herein, the ejector 70 of the invention includes a second stationary helix 5 suitable for placing in or at the outlet from the mixing chamber 64.

This second helix encourages mixing of the phases of the two-phase flow of the primary flow F1 with the secondary flow F2.

1. A nozzle suitable for expanding a saturated flow, said nozzle comprising a converging portion, a throat, and a tube, the nozzle being and a mixer element in said tube downstream from said throat and adapted for fractionating the saturated liquid phase so as to mix it with the vapor phase.

2. The expansion nozzle according to claim 1, wherein said tube is a diverging portion of increasing section.

3. The expansion nozzle according to claim 1, wherein said mixer element is a stationary helix.

4. The expansion nozzle according to claim 1, wherein said mixer element comprises shapes of revolution of increasing sections.

5. The expansion nozzle according to claim 1, wherein said converging portion includes a needle suitable for varying the section of said throat.

6. An ejector comprising a hollow body, said hollow body including a converging portion, a mixing chamber, and a diverging portion, wherein said ejector includes, in said converging portion, an expansion nozzle according to claim 1, said nozzle being adapted for expanding a primary flow of saturated liquid, in order to entrain a secondary flow introduced into said converging portion around said nozzle.

7. The ejector according to claim 6, comprising a second mixer element in part in said mixing chamber and in part in said diverging portion, and adapted for encouraging the two-phase flow of said primary flow at the outlet from said nozzle to mix with said secondary flow.

8. A Hero turbine including at least one hollow arm that is movable in rotation about a shaft, said shaft feeding said hollow arm with saturated liquid, and an expansion nozzle according to claim 1 at the end of said at least one hollow arm.

9. A Pelton turbine including at least two buckets secured to a wheel that is movable in rotation about an axis, and at least one expansion nozzle according to claim 1, and adapted for projecting a two-phase jet towards said buckets.

10. A Francis type turbine including at least one expansion nozzle according to claim 1, and adapted for projecting a two-phase jet towards the inside of a rotor of said turbine.
